(19) United States
(12) Patent Application Publication
(10) Pub. No.: US 2015/0055173 A1
(43) Pub. Date: Feb. 26, 2015

(54) IMAGE FORMING APPARATUS, CONTROL METHOD THEREOF, AND STORAGE MEDIUM

(71) Applicant: CANON KABUSHIKI KAISHA, Tokyo (JP)

(72) Inventor: Satoki Watariuchi, Tokyo (JP)

(21) Appl. No.: 14/459,422

(22) Filed: Aug. 14, 2014

(30) Foreign Application Priority Data
Aug. 21, 2013 (JP) 2013-171097

(51) Int. Cl. G06K 15/00; G06F 3/12

(52) U.S. Cl. CPC G06K 15/4045; G06F 3/1205; G06F 3/1231
USPC 358/1.15

(57) ABSTRACT

An image forming apparatus reads setting value by means of a replace-import processing, and reflects the read setting value if a state of the image forming apparatus indicates that the replace-import processing has not been performed. The replace-import processing indicates an import method for setting according to a replacement. The image forming apparatus adds information indicating that the setting value has been used for original data corresponding to the setting value used in the replace-import processing. Also, the image forming apparatus sets the state of the image forming apparatus to a state indicating that the replace-import processing has been performed after the setting vales are reflected.

### BACKGROUND OF THE INVENTION

1. Field of the Invention

The present invention relates to a technique for preventing an incorrect operation in handover work for setting data due to the replacement of an image forming apparatus.

2. Description of the Related Art

An image forming apparatus controls the behavior of a performance of each function with different setting values. There has been proposed an image forming apparatus having an export function for collectively exporting the aforementioned setting values outside the image forming apparatus.

Japanese Patent Laid-Open No. 2012-226662 discloses an image forming apparatus having an import function for collectively setting exported data as import data.

In the case where an export source apparatus and an import destination apparatus are not the same individual apparatus, separate setting values are not imported. The separate setting values are values that may be allocated to each individual apparatus. For example, an IP address that is information for identifying each apparatus in a TCP/IP network is information unique to the respective apparatuses, and information that should not be directly imported to other apparatuses.

In contrast, upon replacement of an image forming apparatus, labor due to setting work upon replacement is reduced by exporting setting values from an apparatus before replacement in advance, and importing the exported setting values to an apparatus after replacement.

In this situation, in the future, such replacement is assumed and it is contemplated that a special import method is prepared for replacing all settings (including the individual apparatus setting values) for a certain individual apparatus with all the settings of another individual apparatus (hereinafter referred to as “replace-import”). In other words, this replace-import process enables an operation of setting values that are not operable in the case of a normal import process.

Depending on the characteristics of the replace-import process, import data and an apparatus that replace-imports the data are generally one-to-one. For example, replace-importing the same data to a plurality of apparatuses results in a creation of a plurality of apparatuses having the same IP address, which causes inconvenience.

Here, in the case where a plurality of apparatuses are collectively replaced, a human-induced mistake may occur, such as previously used import data being mistakenly used in another apparatus, or other data being imported by overwriting import data that has been imported to an apparatus. However, a method for preventing such an incorrect operation when import data is replace-imported is not conventionally proposed.

### SUMMARY OF THE INVENTION

The present invention provides a technique for preventing incorrect operations when data is imported to an image forming apparatus by means of a replace-import processing.

An image forming apparatus in an embodiment of the present invention includes a reading unit configured to read a setting value in a replace-import processing that enables an operation for a setting value that is not operable in a normal-import processing, wherein the replace-import processing indicates an import method for setting according to a replacement; a reflecting unit configured to reflect the read setting value if a state of the image forming apparatus indicates that the replace-import processing has not been performed; an adding unit configured to add additional information to original data corresponding to the setting value used in the replace-import processing after reflecting the setting value, wherein the additional information indicates that the setting value has been used; and a setting unit configured to set the state of the image forming apparatus to a state indicating that the replace-import processing has been performed.

An image forming apparatus of the present invention enables preventing an incorrect operation when data is imported into an image forming apparatus by a replace-import process.

Further features of the present invention will become apparent from the following description of exemplary embodiments (with reference to the attached drawings).

### BRIEF DESCRIPTION OF THE DRAWINGS

FIG. 1 is a diagram illustrating an example of a system configuration in the present embodiment.

FIG. 2 is a diagram illustrating an example of a hardware configuration of an image forming apparatus.

FIG. 3 is a diagram illustrating export and import processing.

FIG. 4 is a diagram illustrating export and import processing.

FIG. 5 is a diagram illustrating export and import processing.

FIG. 6 is an example of a functional block diagram of the image forming apparatus.

FIG. 7 is an example of operation processing by the image forming apparatus for realizing export processing.

FIG. 8 is a diagram illustrating an example of an import data file.

FIG. 9 is an example of operation processing by the image forming apparatus for realizing import processing.

FIG. 10 is a diagram illustrating an example of an import data file.

FIG. 11 is a diagram illustrating an example of a replace-import history table.

FIG. 12 is a diagram illustrating an example of export and import processing.

FIG. 13 is an example of operation processing by the image forming apparatus for realizing import processing.

### DESCRIPTION OF THE EMBODIMENTS

### First Embodiment

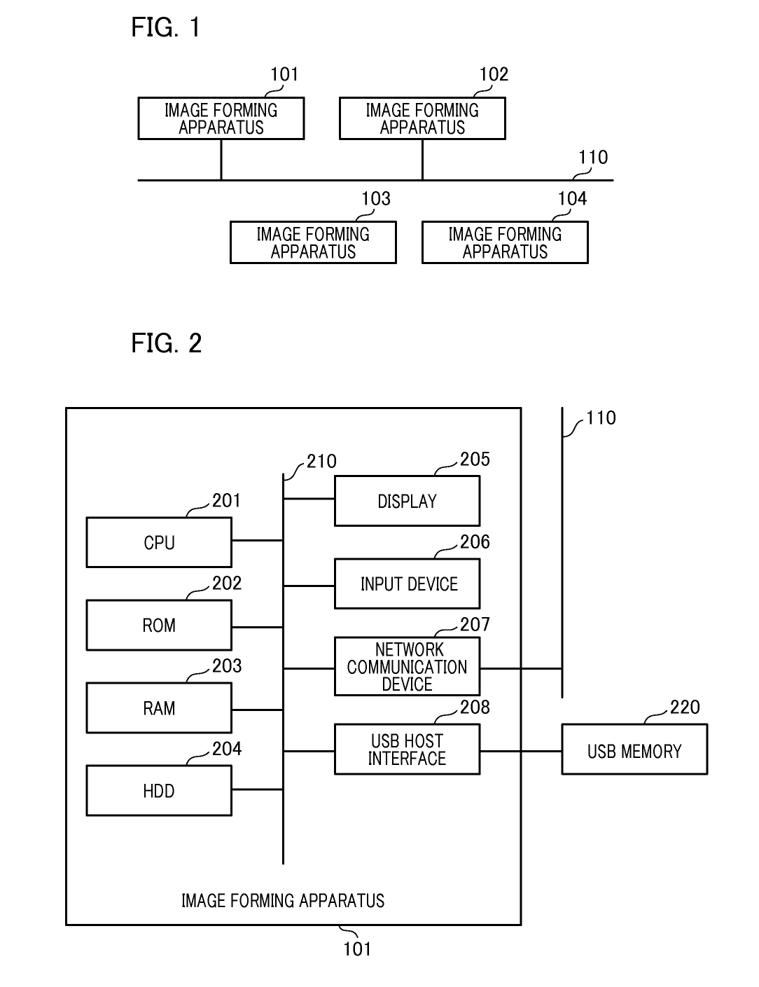

FIG. 1 is a diagram illustrating an example of a system configuration in the present embodiment. In a network environment shown in FIG. 1, there are image forming apparatuses 101 and 102 connected to a LAN 110, and image forming apparatuses 103 and 104 not connected to the LAN 110. LAN is an abbreviation for “Local Area Network”. The image forming apparatuses 101, 102, 103, and 104, which may be multifunction peripherals, have a function for forming an image. Such a function included in these image forming apparatuses will be described below with reference to FIG. 2.

In the present embodiment, the image forming apparatus 101 is replaced with the image forming apparatus 103, and the image forming apparatus 102 is replaced with the image forming apparatus 104. However, the present invention is applicable in cases where there are any number of image forming apparatuses.

FIG. 2 is a diagram illustrating an example of a hardware configuration of the image forming apparatus 101. The image forming apparatus 101 includes a CPU 201, a ROM 202, a RAM 203, an HDD 204, a display 205, an input device 206, a network communication device 207, and a USB host interface 208, which are connected with each other via an internal bus. The image forming apparatuses 102, 103, and 104 have the same configuration as that of the image forming apparatus 101. The CPU (Central Processing Unit) 201 executes programs, controls various processing, and the like. The ROM (Read Only Memory) 202 stores programs and data that are required for an initial stage in activation processing for the apparatus. The RAM (Random Access Memory) 203 is used as a temporary storage area such as a main memory, a working area, and the like for the CPU 201.

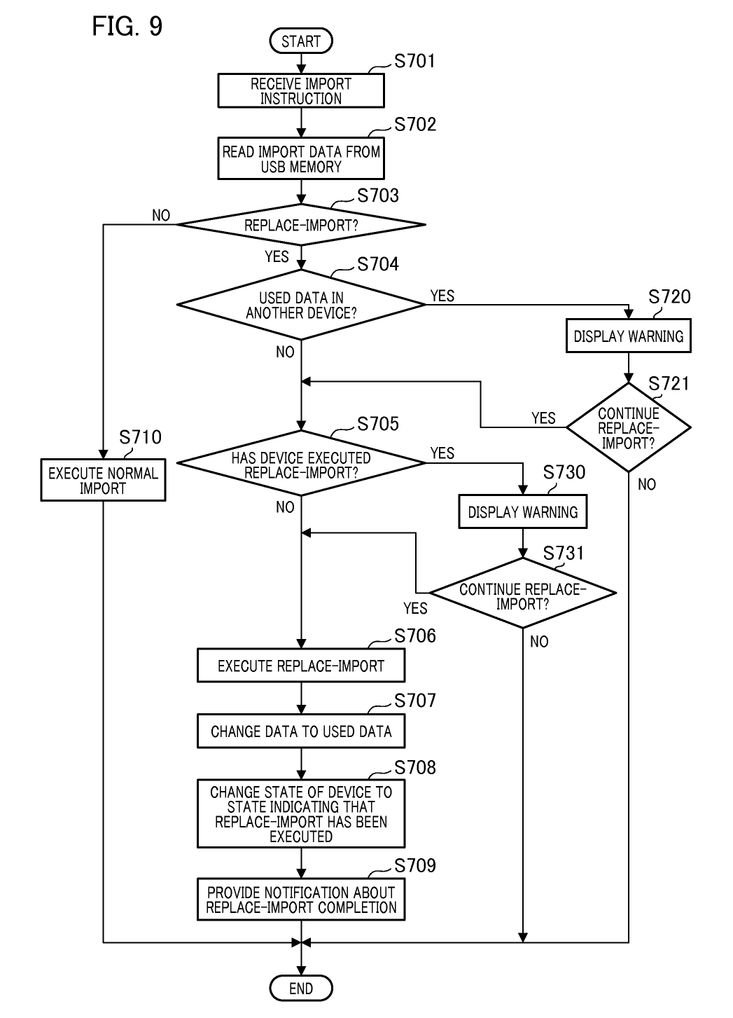

The HDD (Hard Disk Drive) 204 stores image data, various programs, and the like. The HDD 204 is a non-volatile storage device, and thus, can continuously store data even if a power source of the image forming apparatus 101 is turned off. A program for executing export and import of import data is stored in the HDD 204. The CPU 201 reads out this program to the RAM 203, and analyzes and executes it so that processing in FIGS. 7 and 9 is executed.

The display 205 is a display device for conveying information to a user. The input device 206 receives a selection instruction from a user, and transmits it to various programs via the internal bus 210. The network communication device 207 is a device for communicating with other information processing devices via the network.

The USB host interface 208 is an interface that enables usage of a connected USB device. The USB host interface 208 enables, for example, reading and writing data with a USB memory 220 that is an externally connected device.

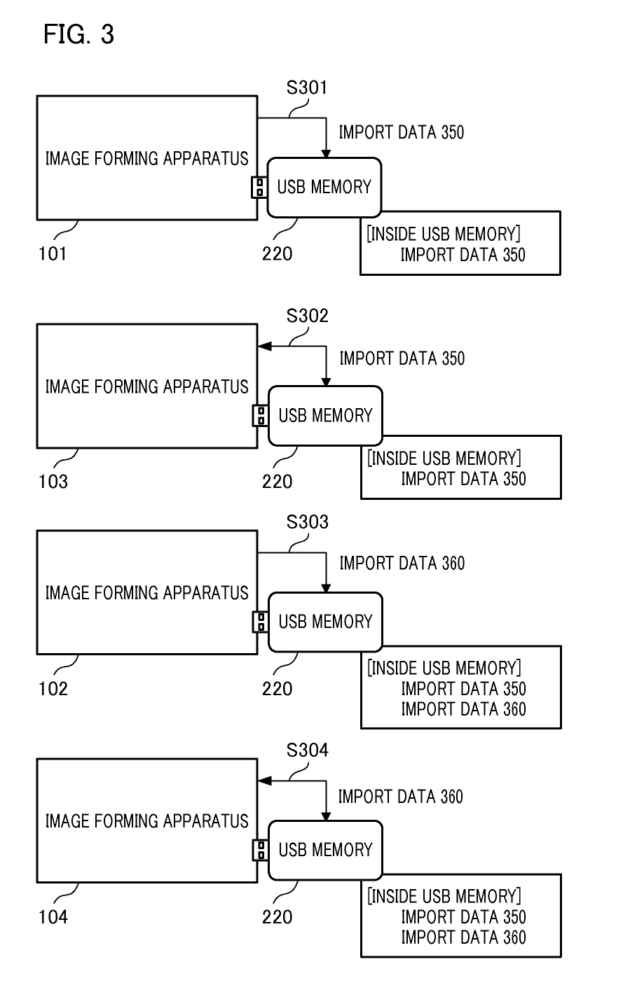

FIGS. 3 to 5 are diagrams illustrating export and import processing in replacement work. FIG. 3 indicates a processing flow in the case where the handover of setting values is normally performed without an incorrect operation.

Upon receiving an export instruction from a worker for replacement work (hereinafter referred to as “the worker”), the image forming apparatus 101 exports a setting value of its own image forming apparatus so as to create import data 350 in the USB memory 220 (step S301).

Also, upon receiving an instruction to replace-import the import data 350 in the USB memory 220 from the worker, the image forming apparatus 103 replace-imports the import data 350 into its own apparatus (step S302). At this time, the image forming apparatus 103 records the fact that its own apparatus has replace-imported the data in the HDD 204 as well as records the fact that the replace-import processing has been performed in the import data 350. The image forming apparatus 103 also confirms that replace-import processing has not been performed and the import data 350 has not been imported to another apparatus other than its own apparatus before executing the replace-import processing.

By performing the processing in steps S301 and S302, the handover of the setting values from the image forming apparatus 101 to the image forming apparatus 103 is completed. Subsequently, upon receiving an export instruction from the worker, the image forming apparatus 102 exports the setting value of its own apparatus so as to create import data 360 in the USB memory 220 (step S303).

Also, upon receiving an instruction to replace-import the import data 360 in the USB memory 220 from the worker, the image forming apparatus 104 replace-imports import data 360 to its own apparatus (step S304). At this time, the image forming apparatus 104 determines whether or not a state of its own apparatus indicates that replace-import processing has been performed before executing the replace-import processing, and reflects the setting values if the image forming apparatus 104 determines that the state of its own apparatus indicates that replace-import processing has not been performed. In this example, the image forming apparatus 104 further determines that the import data 360 has not been replace-imported to another apparatus other than its own apparatus. Specifically, the image forming apparatus 104 determines whether or not information indicating that the import data 360 has been used for another image forming apparatus other than its own apparatus has been added to the import data 360.

In the present embodiment, such information indicating that the import data 360 has been used for the other image forming apparatus other than its own apparatus is not added to the import data 360. Thus, the image forming apparatus 104 implements the replace-import processing so as to reflect the setting values. After reflecting the setting values on the HDD 204, the image forming apparatus 104 records that the state of its own apparatus indicates that replace-import processing has been performed. The image forming apparatus 104 also records (adds) that replace-import processing has been performed in its own apparatus (the data has been used) in the import data 360 that is original data to be replace-imported. By performing the processing in steps S303 and S304, the handover of the setting values from the image forming apparatus 102 to the image forming apparatus 104 is completed.

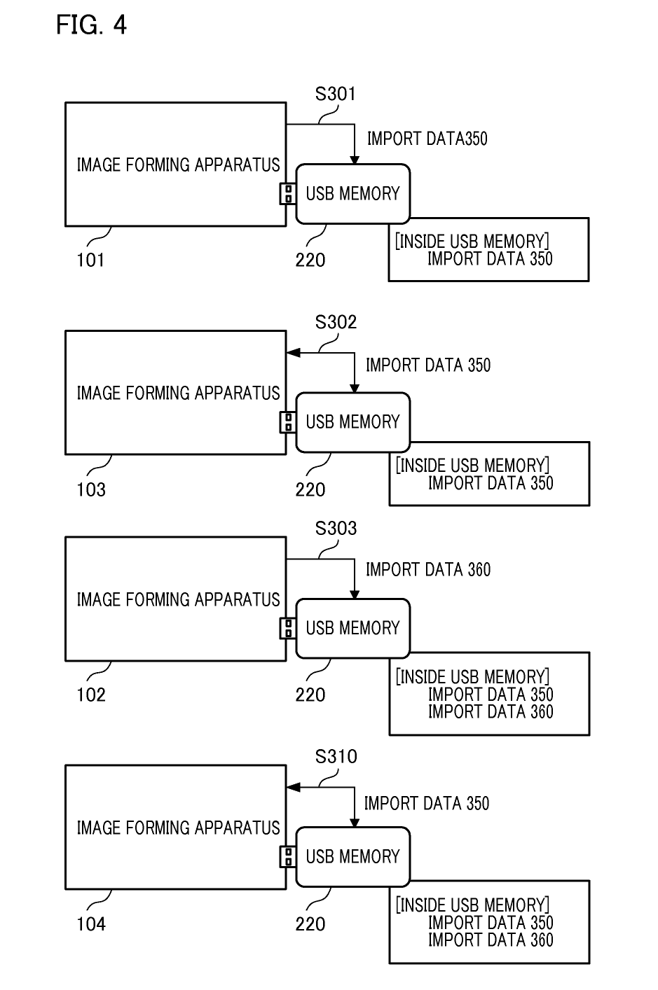

FIG. 4 is a diagram illustrating a flow of processing in the case where the worker has mistakenly performed an operation with incorrect import data. The processing from step S301 to step S303 is the same as that in FIG. 3, and thus, a description thereof is omitted.

In step S310, the image forming apparatus 104 receives an instruction from the worker to replace-import the import data 350 in the USB memory 220. The image forming apparatus 104 determines whether or not replace-import processing has been performed in its own apparatus and the import data 350 has not been replace-imported to the other apparatus other than its own apparatus before executing the replace-import processing.

In the present embodiment, the image forming apparatus 104 detects that the import data 350 has been replace-imported to the image forming apparatus 103, and displays a warning indicating this fact to the worker. By displaying the warning, the image forming apparatus 104 causes the worker to select whether to forcibly continue replace-import processing or cancels the replace-import processing. The image forming apparatus 104 performs processing according to a selection operation by the worker after displaying the warning. With the aforementioned step, the incorrect operation can be prevented by displaying the warning if the worker has mistakenly designated import data.

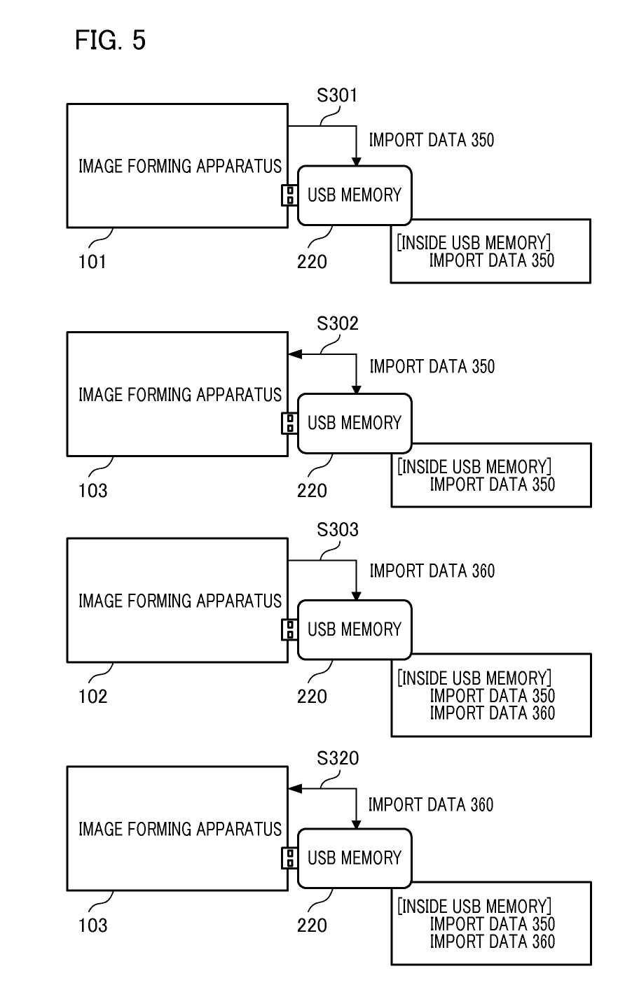

FIG. 5 is a diagram illustrating a flow of the processing in the case where the worker has mistakenly selected an incorrect apparatus that is not subject to import work. The processing in step S301 to step S303 is the same as that in FIG. 3, and thus, a description thereof is omitted.

In step S320, the image forming apparatus 103 receives an instruction from the worker to replace-import the import data 360 in the USB memory 220. The image forming apparatus 103 determines whether or not replace-import processing has not been performed in its own apparatus and the import data 360 has not been replace-imported to the other apparatus other than its own apparatus before the replace-import processing.

In the present embodiment, the image forming apparatus 103 detects the fact that replace-import processing has been performed in its own apparatus, and displays a warning indicating that fact. By displaying the warning, the image forming apparatus 103 causes the worker to select whether to forcibly continue replace-import processing or cancel replace-import processing. The image forming apparatus 103 performs processing according to a selection operation by the worker. With the aforementioned step, an incorrect operation can be prevented by displaying the warning if the worker has mistakenly selected the incorrect apparatus that is not to subject to import work.

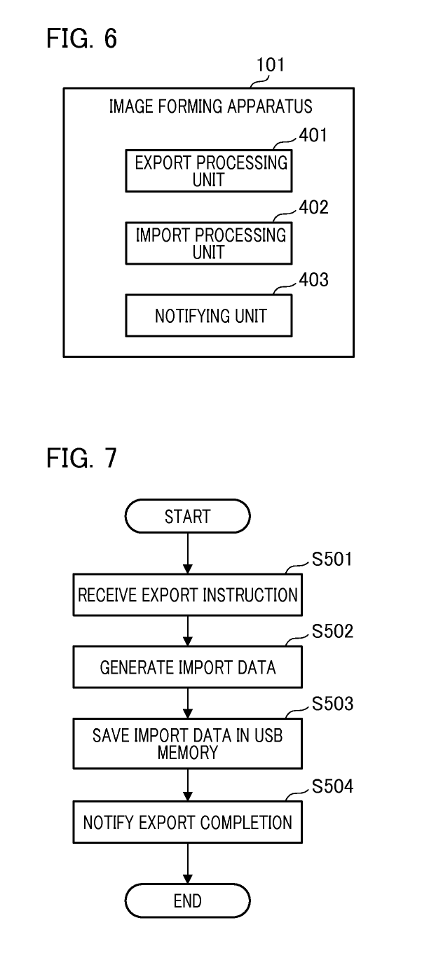

FIG. 6 is an example of a functional block diagram of the image forming apparatus 101. The image forming apparatuses 102, 103, and 104 have the same function as that of the image forming apparatus 101. An export processing unit 401 performs export processing. The export processing unit 401 receives an export instruction from the worker, compiles setting value data for the image forming apparatus 101, and generates import data. The export processing unit 401 exports the generated import data by associating with identification information of its own apparatus.

The import processing unit 402 performs import processing. The import processing unit 402 receives an import instruction from the worker, retrieves setting values from the instructed import data, and reflects them on the image forming apparatus 101. The notifying unit 403 notifies the worker of various information such as an export result, an import result, a warning display, and the like.

FIG. 7 is a flowchart explaining an example of operation processing by the image forming apparatus for realizing the export processing indicated in steps S301 and S303 of FIG. 3. The CPU 201 reads out the program (software) stored in the HDD 204 into the RAM 203, and analyzes and executes so that the processing of the flowchart of FIG. 7 is executed.

The export processing unit 401 receives an export instruction from the worker (step S501). The export instruction from the worker includes the designation of a category. The category indicates a type of setting values for the image forming apparatus.

The category depends on a predefined authority such as a user mode, or a service person mode. For example, there are an “apparatus setting” performed by an administrator, a “hardware setting” performed by a service person, a “user setting” performed by a user, and the like. The image forming apparatus 101 can operate (export/import) a setting of a different category depending on the authority. Note that a scope of the setting included in the category which follows each authority may overlap depending on the authority. Specifically, the administrator authority enables the setting relating to some setting items included in the “user setting” with respect to the “apparatus setting”category.

Also, each category may have the respective setting items that do not overlap with those in other categories. For example, the “hardware setting” performed by the service person has a setting relating to validity/invalidity of a document size detecting function, a setting relating to a coin manager (a setting of a currency type, the minimum amount, or the maximum amount), and the like as the setting items not present in other categories that follow other authority. In addition, for example, the “user setting” performed by the user has a setting of a telephone number for a facsimile as the setting items not existing in the categories that follow other authority.

The export processing unit 401 generates import data in which the setting values in the category to be exported are collected in accordance with the export instruction received in step S501 (step S502), and stores them in the USB memory 220 (step S503). Then, the notifying unit 403 notifies the worker of the fact that export processing has completed by displaying it on the display 205, and terminates the processing (step S504).

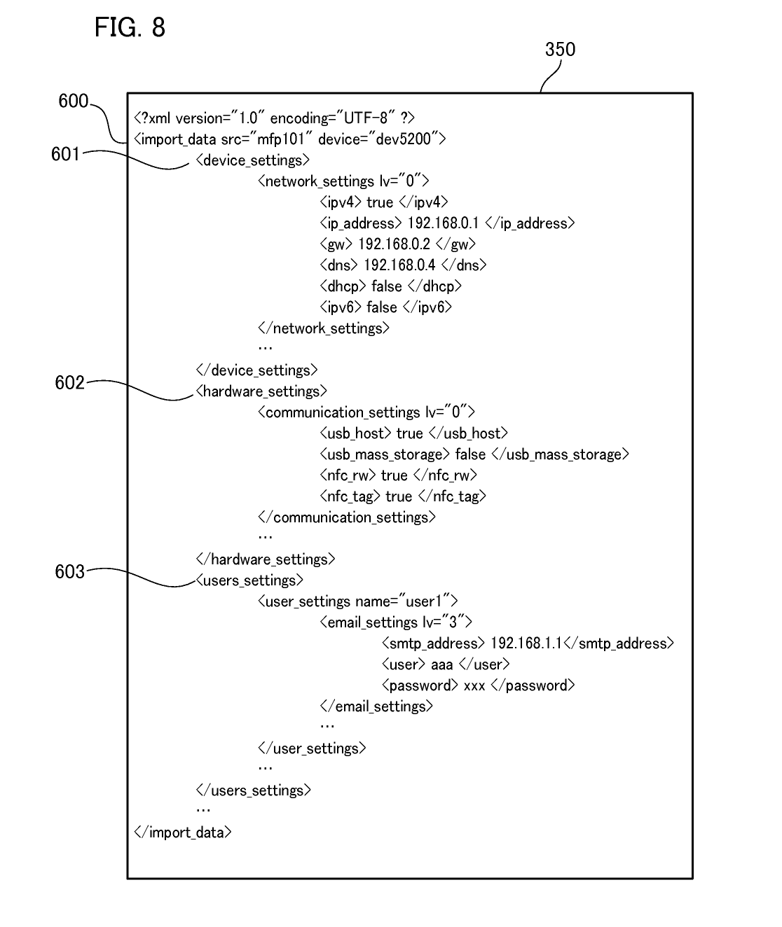

FIG. 8 is a diagram illustrating an example of an import data file. The import data file 350 is saved in the USB memory 220. Although the import data file 350 shown in FIG. 8 is represented as an XML format file for import data, the format is not limited to the XML format and another format may be used.

A tag 600 (<import_data>) indicates that the import data file 350 is import data. In a “src” attribute of the tag 600, information for specifying an export source apparatus (identification information) is defined. In a “device” attribute of the tag 600, information for specifying a model of the export source apparatus is defined. Also, in sub-elements of the tag 600, import data is defined for each category.

A tag 601 (<device_settings>) indicates that this element is import data for the “apparatus setting” category, and setting values for each setting are defined in each sub-element. Also, the attribute “lv” of each setting value tag indicates an apparatus that can import each setting value. For example, a setting value (lv=“0”) indicates a setting value that is imported only if the export source apparatus and the import destination apparatus are the same. A setting value (lv=“1”) indicates a setting value that is imported only if the export source apparatus and the import destination apparatus are the same model.

A setting value (lv=“2”) indicates a setting value that is imported only if the export source apparatus and the import destination apparatus are the model of the same series. A setting value (lv=“3”) indicates a setting value that is imported regardless of the type of the export source apparatus and the import destination apparatus. However, no matter what value “lv” has all setting values are subject to be imported in the case of replace-import processing.

A tag 602 (<hardware_settings>) indicates that the element is import data belonging to the “hardware setting” category, and setting values for each setting are defined in its sub-elements. A tag 603 (<users_settings>) indicates that the element belongs to the “user setting” category, and setting values for each setting are defined in its sub-elements.

In FIG. 8, although three categories are defined for the purpose of explanation, if any data that belongs to another category is present, the data is also defined as the sub-element of the tag 600. Also, each tag shown in FIG. 8 represents the minimum configuration, and the import data file may have information other than the information shown in FIG. 8.

FIG. 9 is a flowchart explaining an example of operation processing by the image forming apparatus for realizing the import processing. Firstly, the import processing unit 402 receives an import instruction from a worker (step S701). At this time, the import instruction from the worker includes a designation of import data (hereinafter referred to as “designated import data”) and designation of a category to be imported (hereinafter referred to as “designated category”). The import instruction further includes information indicating whether processing implemented by the import instruction is normal import processing or replace-import processing. The processing in steps S704, S705, S707, and S708 described below is executed for each setting in the category, that is, for each authority depending on the user, the administrator, the service person, or the like.

The import processing unit 402 reads the designated import data from the USB memory 220 (step S702). Subsequently, the import processing unit 402 determines whether or not the import instruction received in step S701 indicates replace-import processing (step S703). In the case where the import instruction received in step S701 indicates replace-import processing, the processing proceeds to step 704. In the case where the import instruction received in step S701 indicates normal import processing, the import processing unit 402 determines that setting values that can be operated by normal import processing are read. Thus, in this case, the import processing unit 402 does not perform the processing in steps S704 and S705, and the processing proceeds to step S710.

In step S710, the import processing unit 402 executes normal import processing. Specifically, the import processing unit 402 retrieves setting values in the designated category from the designated import data, reflects them on its own apparatus, and terminates the processing. At this time, the import processing unit 402 confirms the “src” tag, the “device” tag, and the “lv” attribute in each setting value in the “import_data” tag, and reflects setting values importable to its own apparatus.

In step S704, the import processing unit 402 determines whether the designated category of the designated import data has been used at another device. The import processing unit 402 uses a “used” attribute in the designated category to thereby determine whether or not the designated category of the designated import data has been used. The “used” attribute is an attribute that is to be recorded by the apparatus that has replace-imported data in step S707 described below.

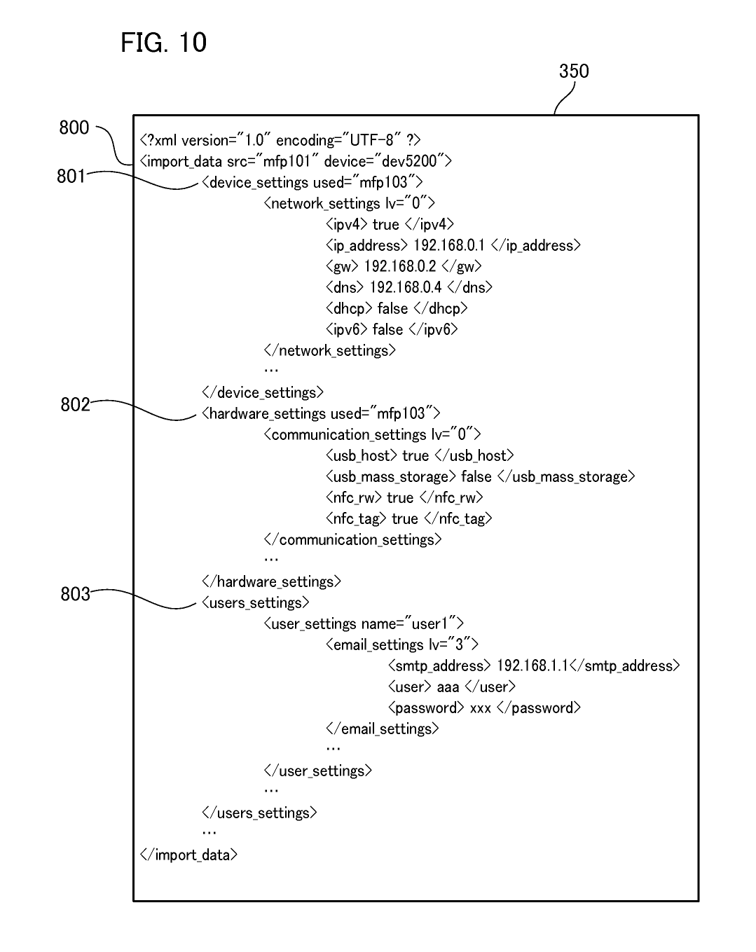

FIG. 10 is a diagram illustrating an example of an import data file. A description will be given of the “used” attribute with reference to FIG. 10. The import data file 350 shown in FIG. 10 is obtained as a result of replace-importing of the import data file 350 in FIG. 8 by the image forming apparatus 103. Assume that the “apparatus setting” category and the “hardware setting” category are designated as the categories to be imported upon replace-import processing.

A tag 800 is the same as the tag 600 in FIG. 8. The “used” attribute is added to a tag 801 from the state shown in the tag 601. “Used=“mfp103”” indicates that the category shown in the tag 801 is replace-imported by an individual apparatus having “mfp103”. Similarly, “used=“mfp103”” described in a tag 802 indicates that the category shown in the tag 802 is replace-imported by an individual apparatus having “mfp103”. On the other hand, a tag 803 has no change from the state of the tag 603 and no description of the “used” attribute, and this means that a replace-import process has not been performed on the tag 803.

Returning to the description of FIG. 9, in step S704, if the designated category of the designated import data has been used at another device, the processing proceeds to step S720. If the designated category of the designated import data has not been used at the another device, the processing proceeds to step S705.

In step S720, the notifying unit 403 warns the worker that the designated category of the designated import data has been used at another device by displaying it on the display 205. The notifying unit 403 also presents, to the worker, options as to whether the worker continues or cancels a replace-import process as well as the warning. The import processing unit 402 determines whether the worker continues or cancels the replace-import process in accordance with a selection by the worker (step S721).

If the worker selects cancelling a replace-import process and the import processing unit 402 determines not to continue the replace-import process, the import processing unit 402 terminates the replace-import process. If the worker selects continuing a replace-import process and the import processing unit 402 determines to continue a replace-import process, the processing proceeds to step S705.

In step S705, the import processing unit 402 determines whether or not the designated category has been replace-imported to its own apparatus. The import processing unit 402 determines whether or not the designated category has been replace-imported in its own apparatus by referring to a replace-import history table. The replace-import history table is recorded in the HDD 204 in step S708 described below.

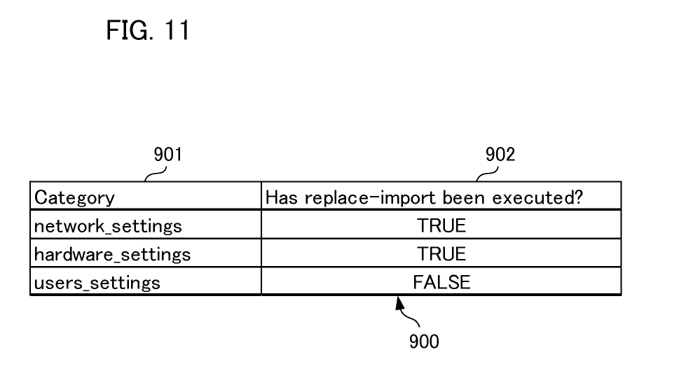

FIG. 11 is a diagram illustrating an example of the replace-import history table. The replace-import history table 900 records a history of replace-import processing by its own apparatus. The replace-import history table 900 is saved in the HDD 204. An item 901 indicates a category, and an item 902 indicates whether or not categories set in an item 902 have been replace-imported. In the example shown in FIG. 11, a “network_settings” category and a “hardware_settings” category have been replace-imported. Also, a “users_settings” category has not been replace-imported.

Returning to the description of FIG. 9, in step S705, if the import processing unit 402 determines that the designated category has been replace-imported to its own apparatus, the processing proceeds to step S730. If the import processing unit 402 determines that the designated category has not been replace-imported to its own apparatus, the processing proceeds to step S706.

In step S730, the notifying unit 403 warns the worker (first warning) that the designated category has been replace-imported to its own apparatus by displaying it on the display 205 (first display). The notifying unit 403 also presents, to the worker, options as to whether the worker continues or cancels a replace-import process as well as the warning. The display executed in the aforementioned step S720 is a second display, that is, a second warning. The import processing unit 402 determines whether to continue or cancel a replace-import process in accordance with a selection by the worker (step S731). If the import processing unit 402 determines not to continue a replace-import process, the processing terminates. If the import processing unit 402 determines to continue a replace-import process, the processing proceeds to step S706.

In step S706, the import processing unit 402 retrieves setting values of the designated category from the designated import data to thereby reflect them on setting values of its own apparatus. At this time, the import processing unit 402 reflects all setting values on setting values of its own apparatus for replace-import processing.

Next, the import processing unit 402 changes the designated category of the designated import data to a state indicating that replace-import processing has been performed (step S707). Specifically, the import processing unit 402 sets the “used” attribute to the tag of the designated category as shown in FIG. 10. The import processing unit 402 sets information that is unique for each individual apparatus and can identify the individual apparatus such as by a serial number to the value in the “used” attribute. In the tag 801 and the tag 802 shown in FIG. 10, the fact that replace-import processing has been performed by an individual apparatus having “mfp103” is recorded as “used=“mfp103””.

Returning to the description of FIG. 9, the import processing unit 402 records the fact that the designated category has been replace-imported to its own apparatus in the HDD 204 (step S708). Specifically, the import processing unit 402 changes the item 902 corresponding to the replace-imported category to an item on which replace-import processing has been performed in the replace-import history table shown in FIG. 11. Finally, the notifying unit 403 notifies the worker of the fact that the import has been completed by displaying it on the display 205 (step S709), and terminates the processing. According to the image forming apparatus in the first embodiment, an incorrect operation can be prevented upon replace-import of import data to the image forming apparatus, resulting in enhanced convenience.

### Second Embodiment

Next, a description will be given of a second embodiment. In the first embodiment, as an incorrect operation upon replace-import processing, the case is assumed where the worker mistakenly selects the incorrect data to be replace-imported or mistakenly selected the incorrect apparatus to which the data is to be replace-imported. In the image forming apparatus in the second embodiment, an incorrect operation can be prevented when the worker mistakenly selects an incorrect apparatus from which data is exported. Since the second embodiment is an extended version of the first embodiment, only differences from the first embodiment are explained.

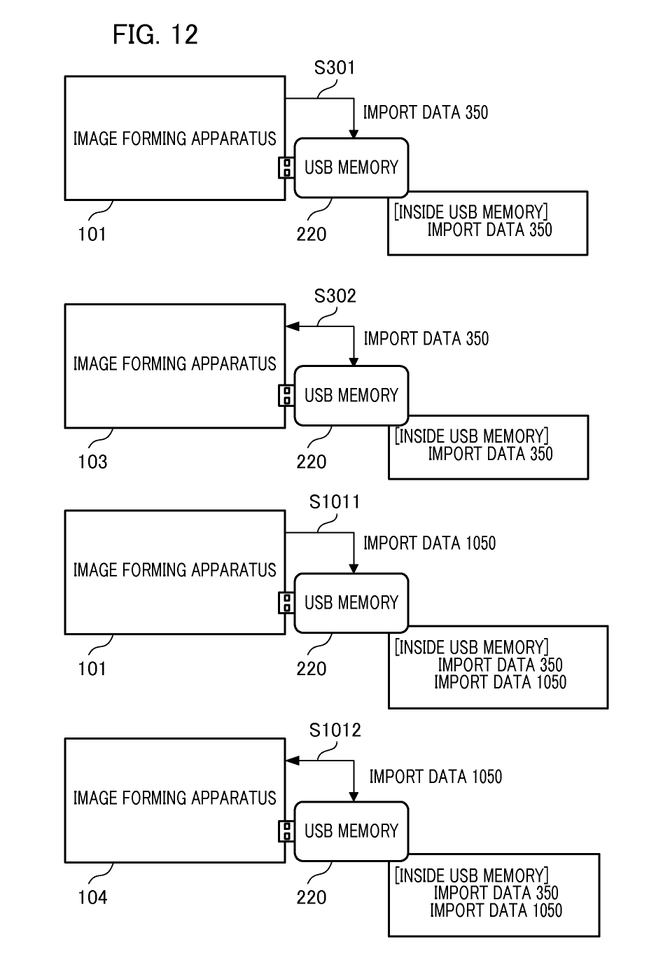

FIG. 12 is a diagram explaining export and import processing in replacement work in the second embodiment. As a premise, it is assumed that the worker has mistakenly selected an incorrect apparatus from which data is exported. Step S301 and step S302 are the same as those in FIG. 3, and thus a description thereof is omitted.

Upon receiving an export instruction from a worker, the image forming apparatus 101 exports its local setting values, and creates import data 1050 in the USB memory 220 (step S1011). At this time, both of the import data 305 and the import data 1050 saved in the USB memory 220 are data in which the setting values of the image forming apparatus 101 are saved. In a normal case, the worker should have performed the export process with respect to the image forming apparatus 102. However, the worker has mistakenly performed the export work with respect to the image forming apparatus 101, and thus this situation occurs.

Next, the image forming apparatus 104 receives an instruction to replace-import the import data 1050 in the USB memory 220 from the worker (step S1012). The image forming apparatus 104 confirms, before the replace-import processing, whether replace-import processing has not been performed in its own apparatus, and the import data 1050 has not been replace-imported to another apparatus other than its own apparatus.

The image forming apparatus 104 further refers to import data that is the same as the import data 1050 of which the export source apparatus is instructed by the worker among import data in the USB memory 220, and determines whether the pertinent import data has been replace-imported.

In this example, the image forming apparatus 104 confirms that the import data 350, for which the export source apparatus is the same image forming apparatus 101, has been replace-imported, and notifies the worker of the fact indicating the warning. The image forming apparatus 104 causes the worker to select whether the worker forcibly continues or cancels replace-import processing by displaying the warning. Upon receiving a selection by the worker, the image forming apparatus 104 performs processing in accordance with the selection by the worker. With this processing, even if the worker mistakenly selects an incorrect apparatus from which data is exported, the warning can be displayed in the case where the import data saved in the export work and the import data of which the export source apparatus are the same. In this manner, an incorrect operation in which import data saved by the aforementioned incorrect export work is replace-imported can be prevented.

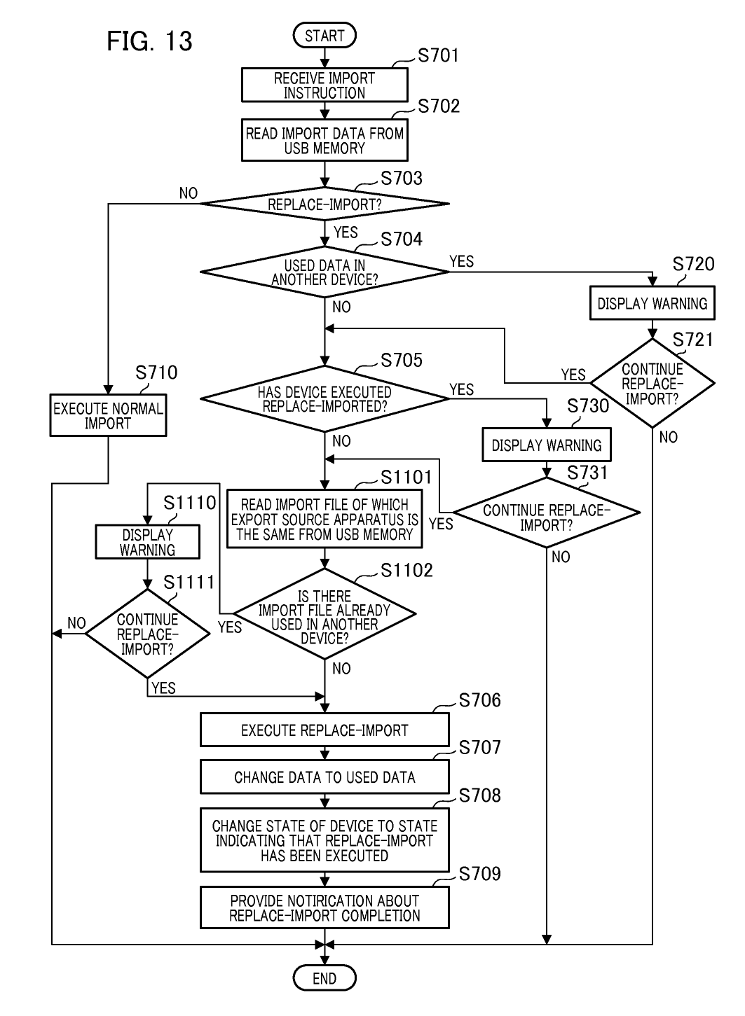

FIG. 13 is a flowchart explaining an example of operation processing by the image forming apparatus for realizing the import processing in the second embodiment. Steps having the same step number shown in FIG. 9 are the same as those in the flowchart of FIG. 9, and thus a description thereof is omitted. The difference between the flowchart shown in FIG. 13 and the flowchart shown in FIG. 9 is additional processing in which an incorrect operation in the export work is checked between step S705 and step S706.

In step S1101, the import processing unit 402 specifies import data of which the export source apparatus is the same as that of the designated import data so as to read it from the USB memory 220. The import processing unit 402 determines the import data of which the export source apparatus is the same based on the “src” attribute in the “import_data” tag.

The import processing unit 402 determines that import data that has the same “src” attribute of “import_data” tag as that of the instructed import data is exported by the same export source apparatus of the instructed import data. Data read by the import processing unit 402 is not limited to one data, but multiple data may be read.

Next, in step S1102, the import processing unit 402 determines whether there is import data of which a designated category has been replace-imported among import data read in step S1101 by using the used attribute. If there is import data of which the designated category has been replace-imported, the processing proceeds to step S1110. If there is no import data of which the designated category has been replace-imported, the processing proceeds to step S706.

In step S1110, the notifying unit 403 warns the worker by displaying the fact that the import data of which the export source apparatus is the same has been replace-imported on the display 205. The notifying unit 403 also presents, to the worker, options as to whether the worker continues or cancels replace-import processing as well as the warning. The import processing unit 402 determines whether to continue or cancel replace-import processing in accordance with a selection by the worker (step S1111).

If the import processing unit 402 determines not to continue replace-import processing, the processing terminates. If the import processing unit 402 determines to continue replace-import processing, the processing proceeds to step S706.

According to the image forming apparatus explained in the second embodiment, an incorrect operation, in which import data saved in an incorrect apparatus that is not a target in the export work is replace-imported, can be prevented.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-171097, filed Aug. 21, 2013, which is hereby incorporated by reference herein in its entirety.

What is claimed is:

1. An image forming apparatus comprising:
a reading unit configured to read a setting value in a replace-import processing that enables an operation for a setting value that is not operable in a normal-import processing, wherein the replace-import processing indicates an import method for setting according to a replacement;
a reflecting unit configured to reflect the read setting value if a state of the image forming apparatus indicates that the replace-import processing has not been performed;
an adding unit configured to add additional information to original data corresponding to the setting value used in the replace-import processing after reflecting the setting value, wherein the additional information indicates that the setting value has been used; and
a setting unit configured to set the state of the image forming apparatus to a state indicating that the replace-import processing has been performed.

2. The image forming apparatus according to claim 1, further comprising:
a first displaying unit configured to control display of a first warning if the state of the image forming apparatus indicates that the replace-import processing has been performed.

3. The image forming apparatus according to claim 2, wherein the reflecting unit forcibly reflects the read setting value in accordance with a selection operation after the first warning is displayed.

4. The image forming apparatus according to claim 1, further comprising a determining unit configured to determine whether or not information indicating that the setting value has been used at another image forming apparatus is added to the original data corresponding to the read setting value,
wherein the reflecting unit reflects the read setting value if the determining unit determines that the information indicating that the setting value has been used for the other image forming apparatus is not added to the original data corresponding to the read setting value and the state of the image forming apparatus indicates that the replace-import processing has not been performed.

5. The image forming apparatus according to claim 4, further comprising a second displaying unit configured to control display of a second warning if the determining unit determines that the information indicating that the setting value has been used at the other image forming apparatus is added to the original data corresponding to the read setting value.

6. The image forming apparatus according to claim 5, wherein the reflecting unit forcibly reflects the read setting value in accordance with a selection operation after the second warning is displayed.

7. The image forming apparatus according to claim 4, wherein the reflecting unit imports the setting value by the normal-import processing regardless of the determination by the determining unit if the setting value that is operable by the normal-import processing is read.

8. The image forming apparatus according to claim 4, wherein, when other data exported from an apparatus that is an export source of the original data corresponding to the read setting value is present, the determining unit further determines whether or not information indicating that the setting value, which has been used at another image forming apparatus, is added to the other data, and
wherein the reflecting unit reflects the read setting value if the determining unit further determines that the information indicating that the other data has been used at the other image forming apparatus is not added to the other data.

9. The image forming apparatus according to claim 1, wherein the reflecting unit imports the setting value by the normal-import processing regardless whether or not the state of the image forming apparatus indicates that the replace-import processing has been performed if the setting value that is operable by the normal-import processing are read.

10. The image forming apparatus according to claim 1, wherein the setting unit sets the state of the image forming apparatus to a state indicating that the replace-import processing has been performed in accordance with an authority when the replace-import processing is instructed,
wherein the reflecting unit reflects the read setting value if the state of the image forming apparatus in accordance with the authority upon the instruction of the replace-import processing indicates that the replace-import processing has not been performed when the replace-import processing is instructed.

11. A control method in an image forming apparatus, the control method comprising:
reading a setting value in a replace-import processing that enables an operation for the setting value that is not operable in a normal-import processing, wherein the replace-import processing indicates an import method for setting according to a replacement;
reflecting the read setting value if a state of the image forming apparatus indicates that the replace-import processing has not been performed;
adding additional information to original data corresponding to the setting value used in the replace-import processing after reflecting the setting value, wherein the additional information indicates that the setting value has been used; and
setting the state of the image forming apparatus to a state indicating that the replace-import processing has been performed.

12. The control method according to claim 11, further comprising determining whether or not information indicating that the setting value has been used at another image forming apparatus is added to original data corresponding to the read setting value,
wherein, in the reflecting, the read setting value is reflected if it is determined that the information indicating that the setting value has been used for the other image forming apparatus is not added to original data corresponding to the read setting value and the state of the image forming apparatus indicates that the replace-import processing has not been performed.

13. A non-transitory storage medium on which is stored a computer program for making a computer execute a control method in an image forming apparatus, the control method comprising:
reading a setting value in a replace-import processing that enables an operation for the setting value that is not operable in a normal-import processing, wherein the replace-import processing indicates an import method for setting according to a replacement;
reflecting the read setting value if a state of the image forming apparatus indicates that the replace-import processing has not been performed;
adding additional information to original data corresponding to the setting value used in the replace-import processing after reflecting the setting value, wherein the additional information indicates that the setting value has been used; and
setting the state of the image forming apparatus to a state indicating that the replace-import processing has been performed.
